(19) United States
(12) Patent Application Publication
(10) Pub. No.: US 2024/0204975 A1
(43) Pub. Date: Jun. 20, 2024

(54) SYSTEMS AND METHODS FOR CANCELLING INTERMODULATION

(71) Applicant: Skyworks Solutions, Inc., Irvine, CA (US)

(72) Inventor: David Richard Pehlke, Westlake Village, CA (US)

(21) Appl. No.: 18/544,246

(22) Filed: Dec. 18, 2023

Related U.S. Application Data
(60) Provisional application No. 63/433,667, filed on Dec. 19, 2022.

(51) Int. Cl. H04L 5/14; H04L 27/00

(52) U.S. Cl. CPC H04L 5/143; H04L 27/0008

(57) ABSTRACT

A mobile device includes an antenna and a radio frequency front-end module coupled to the antenna. The module includes a first radio frequency circuit configured to transmit and receive over a first frequency division duplex communication band, and a second radio frequency circuit configured to transmit and receive over a second frequency division duplex communication band. A baseband processor can be configured to cause the first radio frequency circuit to transmit according to a duty cycle and analyze a signal received during the duty cycling by the first radio frequency circuit or by the second radio frequency circuit. Based on the analysis, the baseband processor can calculate intermodulation distortion between the first radio frequency circuit and the second radio frequency circuit.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

Embodiments of the invention relate to methods and systems for cancelling intermodulation.

### Description of the Related Technology

In some wireless communication systems, such as E-UTRAN New Radio-Dual Connectivity systems (EN-DC), it may be desirable to support simultaneous transmitters being active at the same time. Supporting simultaneous active transmitters may allow for added features and capabilities such as simultaneous radio operation in a user equipment (UE).

In such systems, transmitting from two or more antennas at or near a front-end may be a challenge. For example, the intermodulation between the two transmitted carrier signals may cause desense or a degradation in sensitivity for a receive signal that cannot easily be rectified.

### SUMMARY

According to one embodiment there is provided a mobile device comprising an antenna, and a front-end module coupled to the antenna, the front-end module comprising a first radiofrequency circuit configured to provide a first radiofrequency signal to the antenna, a second radiofrequency circuit configured to provide a second radiofrequency signal to the antenna, a duplexer configured to duplex the first radiofrequency signal and second radiofrequency signal via frequency division duplexing, the first radiofrequency signal being configured to operate according to a duty cycle.

In one example the front-end module is configured to calculate a complex transfer function based on the first radiofrequency signal and the second radiofrequency signal.

In one example the front-end module is configured to calculate an intermodulation signal (IMD) by analyzing a digital signal associated with a third radiofrequency signal received by the antenna during a first time slot when the first and second radiofrequency signals are being transmitted simultaneously by the antenna and during a second time slot when only the second radiofrequency signal is transmitted by the antenna.

In one example the front-end module is configured to remove the calculated intermodulation (IMD) signal from the digital signal associated with the third radiofrequency signal.

Another example further comprises a transceiver for generating the first and second radiofrequency signals for transmitting via the antenna and for processing a third radiofrequency signal received from the antenna.

Another example further comprises a power management system for controlling a supply voltage applied to the first radiofrequency circuit and the second radiofrequency circuit.

In one example the duty cycle has a frequency corresponding to a time division duplexing frequency band.

Another example further comprises a baseband system for processing digital signals associated with a third radiofrequency signal received by the antenna.

In one example the first radiofrequency circuit and the second radiofrequency circuit each comprise a power amplifier, a low noise amplifier and a filter.

In one example the first radiofrequency signal is a fourth generation (4G) frequency band and the second radiofrequency signal is a fifth generation (5G) frequency band, or wherein the first radiofrequency signal is a fifth generation (5G) frequency band and the second radiofrequency signal is a fourth generation (4G) frequency band.

According to another embodiment there is provided a method comprising providing a first radiofrequency signal to an antenna with a first radiofrequency circuit, providing a second radiofrequency signal to the antenna with a second radiofrequency circuit, duplexing the first radiofrequency signal and second radiofrequency signal via frequency division duplexing, and operating the first radiofrequency circuit according to a duty cycle.

One example further comprises calculating a complex transfer function based on the first radiofrequency signal and the second radiofrequency signal.

Another example further comprises calculating an intermodulation signal (IMD) by analyzing a digital signal associated with a third radiofrequency signal received by the antenna during a first time slot when the first and second radiofrequency signals are being transmitted simultaneously by the antenna and during a second time slot when only the second radiofrequency signal is transmitted by the antenna.

Another example further comprises removing the calculated intermodulation (IMD) signal from the digital signal associated with the third radiofrequency signal.

Another example further comprises generating, with a transceiver, the first and second radiofrequency signals and processing, with the transceiver, a third radiofrequency signal.

Another example further comprises controlling a supply voltage applied to the first radiofrequency circuit and the second radiofrequency circuit with a power management system.

In one example the duty cycle has a frequency corresponding to a time division duplexing frequency band.

Another example further comprises processing digital signals associated with a third radiofrequency signal received by the antenna with a baseband system.

In one example the first radiofrequency signal is a fourth generation (4G) frequency band and the second radiofrequency signal is a fifth generation (5G) frequency band, or wherein the first radiofrequency signal is a fifth generation (5G) frequency band and the second radiofrequency signal is a fourth generation (4G) frequency band.

According to another embodiment there is provided a front-end module comprising a first radiofrequency circuit configured to provide a first radiofrequency signal to the antenna, a second radiofrequency circuit configured to provide a second radiofrequency signal to the antenna, and a duplexer configured to duplex the first radiofrequency signal and second radiofrequency signal via frequency division duplexing, the first radiofrequency signal being configured to operate according to a duty cycle.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a schematic diagram of an example dual connectivity network topology;

FIG. 2 is a schematic diagram of an example communication network;

FIG. 3A is a schematic diagram of an example communication link using carrier aggregation;

FIG. 3B is a schematic diagram of various examples of uplink carrier aggregation for the communication link shown in FIG. 3A;

FIG. 4 is a schematic diagram of an example mobile device;

FIG. 5 is a simplified schematic diagram of an example radio front end system that may be implemented in the mobile device shown in FIG. 4;

FIG. 6A is a graph illustrating an implementation of frequency division duplex (FDD) communication in the frequency domain in accordance with aspects of this disclosure;

FIG. 6B is a graph illustrating an implementation of time division duplex (TDD) communication in the frequency domain in accordance with aspects of this disclosure;

FIG. 7 is a graph illustrating an implementation of FDD communication in accordance with aspects of this disclosure; and

FIG. 8 is a graph illustrating duty cycling of an FDD uplink channel in accordance with aspects of this disclosure.

### DETAILED DESCRIPTION

Aspects and embodiments described herein are directed to methods and systems for mitigating intermodulation (IMD) arising from the simultaneous transmission of two signals, for example during dual connectivity or carrier aggregation operations. This advantageously enables a more accurate calculation of the IMD caused by simultaneously transmitting two signals in different frequency bands, which could otherwise result in the degradation of a receive channel signal, Rx DeSense, of up to 20 dB.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), fourth generation (4G) technology (for instance, Long Term Evolution (LTE) and LTE Advanced) and fifth generation (5G) technology, also referred to herein as 5G New Radio (NR).

5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

5G NR may be implemented as a standalone core network architecture, whereby 5G mmWave links are maintained independently without requiring the support of an underlying previous-generation technology architecture. However, 3GPP has allowed for the simultaneous operation of 5G and 4G standards in order to facilitate the transition to a standalone 5G core network. This mode can be referred to as Non-Stand-Alone (NSA) 5G operation or E-UTRAN New Radio-Dual Connectivity (ENDC) and involves both 4G and 5G carriers being simultaneously transmitted from a user equipment (UE).

In certain EN-DC applications, dual connectivity NSA involves overlaying 5G systems onto an existing 4G core network. For dual connectivity in such applications, the control and synchronization between the base station and the UE can be performed by the 4G network while the 5G network is a complementary radio access network tethered to the 4G anchor. The 4G anchor can connect to the existing 4G network with the overlay of 5G data/control.

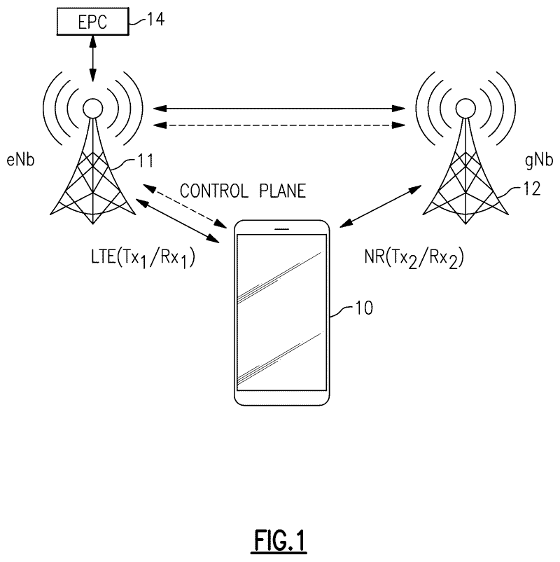

FIG. 1 is a diagram of an example dual connectivity network topology. This architecture can leverage LTE legacy coverage to ensure continuity of service delivery and the progressive rollout of 5G cells. A UE 10 can simultaneously transmit dual uplink LTE and NR carrier. The UE 10 can transmit an uplink LTE carrier TX1 to the eNB 11 while transmitting an uplink NR carrier TX2 to the gNB 12 to implement dual connectivity. Any suitable combination of uplink carriers TX1, TX2 and/or downlink carriers RX1, RX2 can be concurrently transmitted via wireless links in the example network topology of FIG. 1. The eNB 11 can provide a connection with a core network, such as an Evolved Packet Core (EPC) 14. The gNB 12 can communicate with the core network via the eNB 11. Control plane data can be wireless communicated between the UE 10 and eNB 11. The eNB 11 can also communicate control plane data with the gNB 12. Control plane data can propagate along the paths of the dashed lines in FIG. 1. The solid lines in FIG. 1 are for data plane paths.

In the example dual connectivity topology of FIG. 1, any suitable combinations of standardized bands and radio access technologies (e.g., FDD, TDD, SUL, SDL) can be wirelessly transmitted and received. This can present technical challenges related to having multiple separate radios and bands functioning in the UE 10.

With a TDD LTE anchor point, network operation may be synchronous, in which case the operating modes can be constrained to TX1/TX2 and RX1/RX2, or asynchronous which can involve TX1/TX2, TX1/RX2, RX1/TX2, RX1/RX2. When the LTE anchor is a frequency division duplex (FDD) carrier, the TDD/FDD inter-band operation can involve simultaneous transmit and receive operating modes such as TX1/RX1/TX2 and TX1/RX1/RX2.

Concurrent transmissions of any suitable combination of an LTE band transmission and an NR band transmission can be implemented. Any other suitable combination of concurrent transmissions associated with two different radio access technologies can be implemented in accordance with any suitable principles and advantages disclosed herein.

Although certain embodiments disclosed herein are related to dual connectivity operation, any suitable principles and advantages disclosed herein can be implemented in other applications where a plurality of radio frequency signals are being concurrently generated for transmission. For instance, any suitable combination of features described with reference to dual connectivity can be implemented in association with carrier aggregation. The carrier aggregation can be an uplink carrier aggregation. As another example, any suitable combination of features described with reference to dual connectivity can be implemented in association with multiple-input multiple-output (MIMO) communications. The MIMO communication can be an uplink MIMO communication.

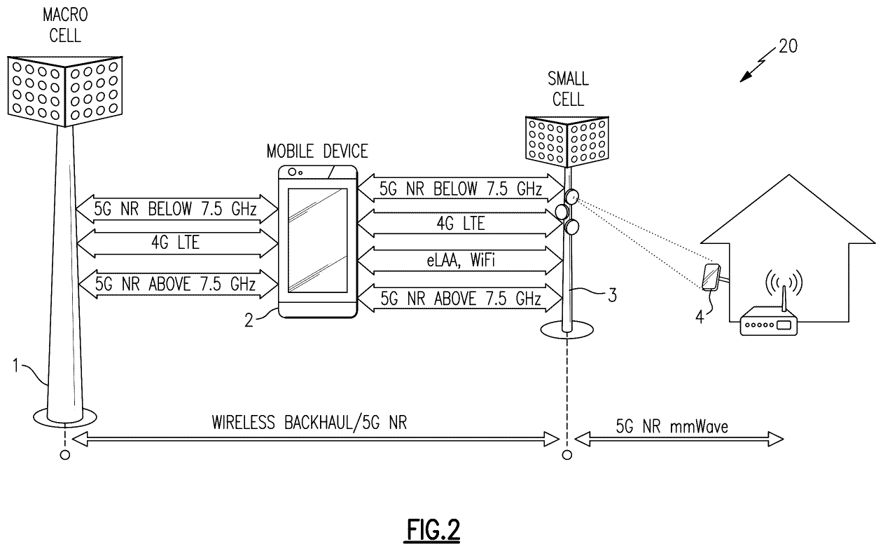

FIG. 2 is a schematic diagram of one example of a communication network 20. The communication network 20 includes a macro cell base station 1, a mobile device 2, a small cell base station 3, and a stationary wireless device 4.

The illustrated communication network 20 of FIG. 2 supports communications using a variety of technologies, including, for example, 4G LTE, 5G NR, and wireless local area network (WLAN), such as Wi-Fi. In the communication network 20, dual connectivity can be implemented with concurrent 4G LTE and 5G NR communication with the mobile device 2. Although various examples of supported communication technologies are shown, the communication network 20 can be adapted to support a wide variety of communication technologies.

Various communication links of the communication network 20 have been depicted in FIG. 2. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

As shown in FIG. 2, the mobile device 2 communicates with the macro cell base station 1 over a communication link that uses a combination of 4G LTE and 5G NR technologies. The mobile device 2 also communications with the small cell base station 3. In the illustrated example, the mobile device 2 and small cell base station 3 communicate over a communication link that uses 5G NR, 4G LTE, and Wi-Fi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed Wi-Fi frequencies).

In certain implementations, the mobile device 2 communicates with the macro cell base station 2 and the small cell base station 3 using 5G NR technology over one or more frequency bands that are less than 7.5 Gigahertz (GHz) and/or over one or more frequency bands that are greater than 7.5 GHz. For example, wireless communications can utilize Frequency Range 1 (FR1), Frequency Range 2 (FR2), or a combination thereof. In one embodiment, the mobile device 2 supports a High Power User Equipment (HPUE) power class specification.

The illustrated small cell base station 3 also communicates with a stationary wireless device 4. The small cell base station 3 can be used, for example, to provide broadband service using 5G NR technology. In certain implementations, the small cell base station 3 communicates with the stationary wireless device 4 over one or more millimeter wave frequency bands in the frequency range of 30 GHz to 300 GHz and/or upper centimeter wave frequency bands in the frequency range of 24 GHz to 30 GHz.

The communication network 20 of FIG. 2 includes the macro cell base station 1 and the small cell base station 3. In certain implementations, the small cell base station 3 can operate with relatively lower power, shorter range, and/or with fewer concurrent users relative to the macro cell base station 1. The small cell base station 3 can also be referred to as a femtocell, a picocell, or a microcell.

Although the communication network 20 is illustrated as including two base stations, the communication network 20 can be implemented to include more or fewer base stations and/or base stations of other types. As shown in FIG. 2, base stations can communicate with one another using wireless communications to provide a wireless backhaul. Additionally or alternatively, base stations can communicate with one another using wired and/or optical links.

The communication network 20 of FIG. 2 is illustrated as including one mobile device and one stationary wireless device. The mobile device 2 and the stationary wireless device 4 illustrate two examples of user devices or user equipment (UE). Although the communication network 20 is illustrated as including two user devices, the communication network 20 can be used to communicate with more or fewer user devices and/or user devices of other types. For example, user devices can include mobile phones, tablets, laptops, Internet of Things (IoT) devices, wearable electronics, and/or a wide variety of other communications devices.

Enhanced mobile broadband (eMBB) refers to technology for growing system capacity of LTE networks. For example, eMBB can refer to communications with a peak data rate of at least 10 Gbps and a minimum of 100 Mbps for each user device. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with IoT applications.

The communication network 20 of FIG. 2 can be used to support a wide variety of advanced communication features, including, but not limited to eMBB, uRLLC, and/or mMTC.

A peak data rate of a communication link (for instance, between a base station and a user device) depends on a variety of factors. For example, peak data rate can be affected by channel bandwidth, modulation order, a number of component carriers, and/or a number of antennas used for communications.

For instance, in certain implementations, a data rate of a communication link can be about equal to M*B*log₂ (1+S/N), where M is the number of communication channels, B is the channel bandwidth, and S/N is the signal-to-noise ratio (SNR).

Accordingly, data rate of a communication link can be increased by increasing the number of communication channels (for instance, transmitting and receiving using multiple antennas), using wider bandwidth (for instance, by aggregating carriers), and/or improving SNR (for instance, by increasing transmit power and/or improving receiver sensitivity).

5G NR communication systems can employ a wide variety of techniques for enhancing data rate and/or communication performance.

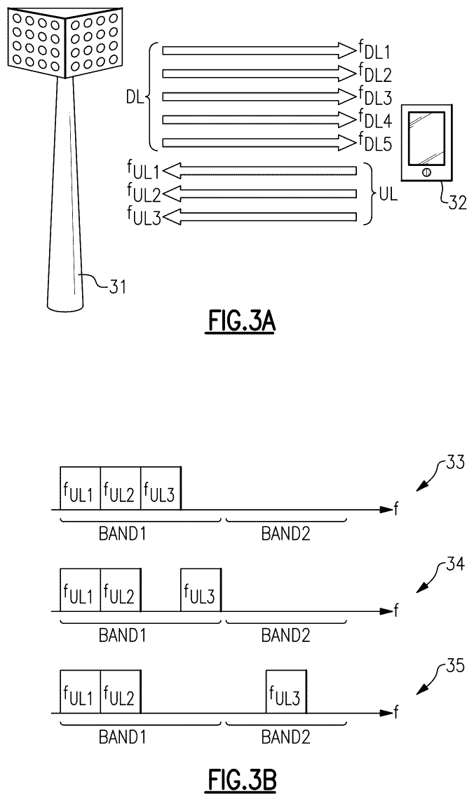

FIG. 3A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 31 and a mobile device 32. As shown in FIG. 3A, the communications link includes a downlink channel used for RF communications from the base station 31 to the mobile device 32, and an uplink channel used for RF communications from the mobile device 32 to the base station 31.

Although FIG. 3A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 31 and the mobile device 32 communicate via carrier aggregation, which can be used to selectively increase bandwidth of the communication link Carrier aggregation includes contiguous aggregation, in which contiguous carriers within the same operating frequency band are aggregated. Carrier aggregation can also be non-contiguous, and can include carriers separated in frequency within a common band or in different bands.

In the example shown in FIG. 3A, the uplink channel includes three aggregated component carriers f_UL1, f_UL2 and f_UL3. Additionally, the downlink channel includes five aggregated component carriers f_DL1, f_DL2, f_DL3, f_DL4 and f_DL5. Although one example of component carrier aggregation is shown, more or fewer carriers can be aggregated for uplink and/or downlink Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 3B illustrates various examples of uplink carrier aggregation for the communication link of FIG. 3A. FIG. 3B includes a first carrier aggregation scenario 33, a second carrier aggregation scenario 34, and a third carrier aggregation scenario 35, which schematically depict three types of carrier aggregation.

The carrier aggregation scenarios 33-35 illustrate different spectrum allocations for a first component carrier f_UL1, and, a second component carrier f_UL2 , and a third component carrier f_UL3. Although FIG. 3B is illustrated in the context of aggregating three component carriers, carrier aggregation can be used to aggregate more or fewer carriers. Moreover, although illustrated in the context of uplink, the aggregation scenarios are also applicable to downlink

The first carrier aggregation scenario 33 illustrates intra-band contiguous carrier aggregation, in which component carriers that are adjacent in frequency and in a common frequency band are aggregated. For example, the first carrier aggregation scenario 33 depicts aggregation of component carriers f_UL1, f_UL2 and f_UL3 that are contiguous and located within a first frequency band BAND1.

With continuing reference to FIG. 3B, the second carrier aggregation scenario 34 illustrates intra-band noncontinuous carrier aggregation, in which two or more components carriers that are non-adjacent in frequency and within a common frequency band are aggregated. For example, the second carrier aggregation scenario 34 depicts aggregation of component carriers f_UL1, f_UL2 and f_UL3 that are non-contiguous, but located within a first frequency band BAND1.

The third carrier aggregation scenario 35 illustrates inter-band non-contiguous carrier aggregation, in which component carriers that are non-adjacent in frequency and in multiple frequency bands are aggregated. For example, the third carrier aggregation scenario 35 depicts aggregation of component carriers f_UL1 and f_UL2 of a first frequency band BAND1 with component carrier f_UL3 of a second frequency band BAND2.

With reference to FIGS. 3A-3B, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and secondary cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as Wi-Fi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid Wi-Fi users and/or to coexist with Wi-Fi users. Enhanced license assisted access (eLAA) refers to an evolution of LAA that aggregates licensed and unlicensed spectrum for both downlink and uplink.

Modern wireless communication systems, such as LTE, LTE-Advanced and 5G NR, include added features and capabilities such as simultaneous radio operation in a user equipment (UE) that make it necessary or desirable to support simultaneous transmitters being active at the same time. However, relatively high power signals from two or more TX carriers being routed and/or processed at or near a front-end can be a challenge. For example, simultaneously operating the 4G uplink signal path (i.e. TX1 path) and the 5G uplink signal path (i.e. the TX2 path) produces IMD between the TX1 and TX2 signal carriers that is extremely difficult to accurately model, and thus remove from the baseband signal.

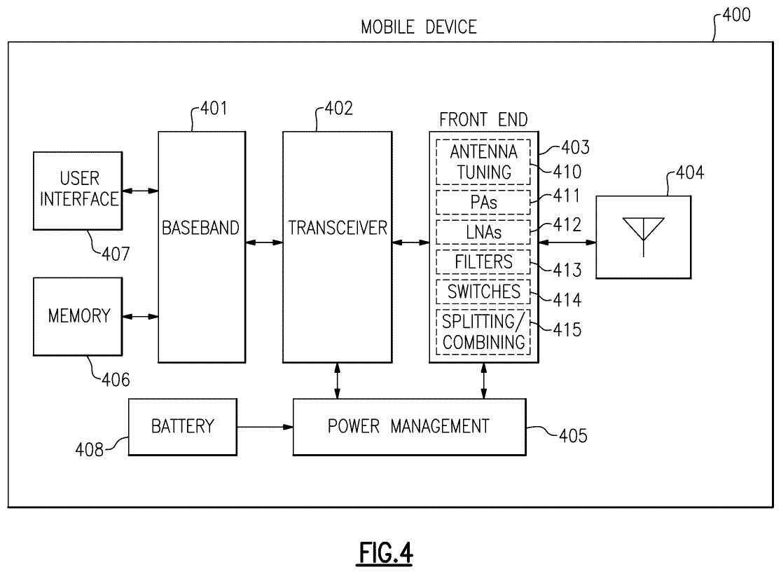

FIG. 4 is a schematic diagram of one embodiment of a mobile device 400. The mobile device 400 includes a baseband system 401, a transceiver 402, a front end system 403, antennas 404, a power management system 405, a memory 406, a user interface 407, and a battery 408.

The mobile device 400 can be used communicate using a wide variety of communications technologies, including, but not limited to, 2G, 3G, 4G (including LTE, LTE-Advanced, and LTE-Advanced Pro), 5G NR, WLAN (for instance, WiFi), WPAN (for instance, Bluetooth and ZigBee), WMAN (for instance, WiMax), and/or GPS technologies.

The transceiver 402 generates RF signals for transmission and processes incoming RF signals received from the antennas 404. It will be understood that various functionalities associated with the transmission and receiving of RF signals can be achieved by one or more components that are collectively represented in FIG. 4 as the transceiver 402. In one example, separate components (for instance, separate circuits or dies) can be provided for handling certain types of RF signals. For example, the transceiver can generate analog RF signals based on digital signals provided by the baseband system 401.

The front end system 403 aids in conditioning signals transmitted to and/or received from the antennas 404. In the illustrated embodiment, the front end system 403 includes antenna tuning circuitry 410, power amplifiers (PAs) 411, low noise amplifiers (LNAs) 412, filters 413, switches 414, and signal splitting/combining circuitry 415. However, other implementations are possible. For example, the front end system 403 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 400 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 404 can include antennas used for a wide variety of types of communications. For example, the antennas 404 can include antennas for transmitting and/or receiving signals associated with a wide variety of frequencies and communications standards.

In certain implementations, the antennas 404 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 400 can operate with beamforming in certain implementations. For example, the front end system 403 can include amplifiers having controllable gain and phase shifters having controllable phase to provide beam formation and directivity for transmission and/or reception of signals using the antennas 404. For example, in the context of signal transmission, the amplitude and phases of the transmit signals provided to the antennas 404 are controlled such that radiated signals from the antennas 404 combine using constructive and destructive interference to generate an aggregate transmit signal exhibiting beam-like qualities with more signal strength propagating in a given direction. In the context of signal reception, the amplitude and phases are controlled such that more signal energy is received when the signal is arriving to the antennas 404 from a particular direction. In certain implementations, the antennas 404 include one or more arrays of antenna elements to enhance beamforming

The baseband system 401 is coupled to the user interface 407 to facilitate processing of various user input and output, such as voice and data. The baseband system 401 provides the transceiver 402 with digital representations of transmit signals, which the transceiver 402 processes to generate RF signals for transmission. The baseband system 401 also processes digital representations of received signals provided by the transceiver 402. As shown in FIG. 4, the baseband system 401 is coupled to the memory 406 of facilitate operation of the mobile device 400.

The memory 406 can be used for a wide variety of purposes, such as storing data and/or instructions to facilitate the operation of the mobile device 400 and/or to provide storage of user information.

The power management system 405 provides a number of power management functions of the mobile device 400. In certain implementations, the power management system 405 includes a PA supply control circuit that controls the supply voltages of the power amplifiers 411. For example, the power management system 405 can be configured to change the supply voltage(s) provided to one or more of the power amplifiers 411 to improve efficiency, such as power added efficiency (PAE).

As shown in FIG. 4, the power management system 405 receives a battery voltage from the battery 408. The battery 408 can be any suitable battery for use in the mobile device 400, including, for example, a lithium-ion battery.

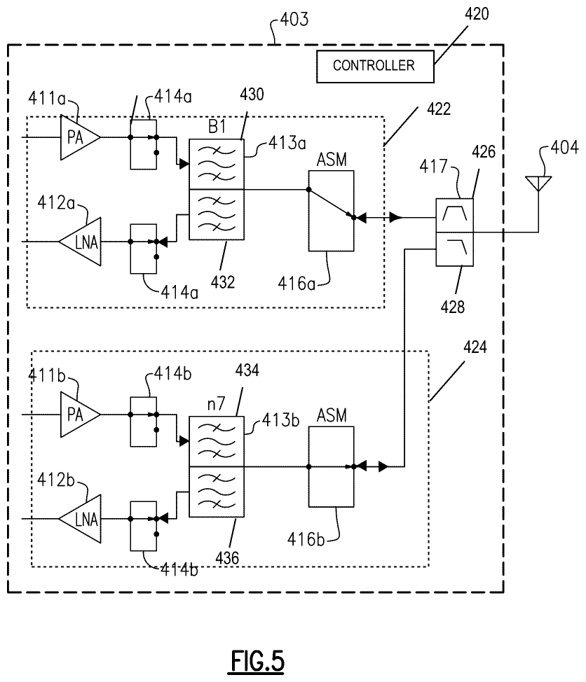

FIG. 5 is a simplified schematic diagram of one embodiment of a radio front end system 403 which can be implemented in the mobile device 400 illustrated in FIG. 4 in accordance with aspects of this disclosure. In the illustrated embodiment, the front end system 403 is connected to an antenna 404.

The front end system 403 is coupled to an antenna 404 via a multiplexer 417. The multiplexer 417 (which can also be referred to as an antenna-plexer) of the illustrated embodiment is a diplexer configured to communicate signals between the antenna 404 and first and second FDD communication paths 422, 424 (which can also be referred to as first and second radio frequency circuits). The first FDD communication path 422 is connected to a first portion 426 of the multiplexer 417, which can include a filter with a passband wide enough to encompass at least LTE B1 and any other bands supported by the first FDD communication path 422. The second communication path 424 is connected to a second portion of the multiplexer 417, which can include a filter with a passband wide enough to encompass at least 5G n7 and any other bands supported by the communication path 424. For example, in one embodiment, the first portion 426 is a passband filter and the second portion 428 is a low pass filter, although other types of filters can be used.

The first FDD communication path 422 includes a power amplifier (PA) 411a, a low noise amplifier (LNA) 412a, a first duplexer 413a including a transmit filter 430 and a receive filter 432, a plurality of switches 414a, and an antenna switch module (ASM) 416a. In preferred embodiments, as shown in FIG. 5, the first FDD communication path 422 is configured to process 4 G RF signals, such as signals in FDD LTE band B1 that have an approximate UL frequency range of between 1920 and 1980 MHz and an approximate DL frequency range of between 2110 and 2170 MHz. For example, the transmit filter 430 of the first duplexer 413a can have a passband of between about 1920 to 1980 MHz and the receive filter 432 of the second duplexer 413b can have a passband of between about 2110 and 2170 Mhz.

The second FDD communication path 424 includes PA 411b, LNA 412b, a second duplexer 413b including a transmit filter 434 and a receive filter 436, switches 414b, and ASM 416b. In preferred embodiments, as shown in FIG. 5, the second FDD communication path 424 is configured to process 5 G RF signals, such as signals in FDD NR band n7 that have an approximate UL frequency range of between 2500 and 2670 MHz and an approximate DL frequency range of between 2620 and 2690 MHz. For example, the transmit filter 434 of the second duplexer 413b can have a passband of between about 2500 and 2670 MHz and the receive filter 436 of the second duplexer 413b can have a passband of between about 2620 and 2690 Mhz.

While the multiplexer 417 of the illustrated front end system 403 is a diplexer configured to multiplex between a single port connected to the antenna 404 and the two ports connected to the respective antenna switch modules 416a, 416b, in other implementations the front end system 403 can include additional paths for communicating additional bands and/or additional antennas. In such cases the multiplexer 417 can be a higher order multiplexer Similarly, while the antenna switch modules 416a, 416b each illustrate only a single path for the purposes of illustration, it will be appreciated that in other embodiments, such as where the front end system 403 connects to multiple antennas, one or more the antenna switch modules 416a, 416b can be higher order switches to facilitate connection between additional antennas and/or communication bands. Further, as reflected by the unconnected port on each of the band switches 414a, 414b, each of the band switches 414a, 414b can each be configured to selectively connect the respective PAs 411a, 411b and/or LNAs 412a, 412b to an additional communication path, although the additional communication paths are not shown in FIG. 5 for ease of illustration.

The front end system 403 additionally includes a controller 420, which can comprises one or more microcontroller integrated circuits or other processors. The controller 420 can be configured to receive commands from the baseband processor 401 and/or transceiver 402 for controlling the various components of the front end system 403. For example, the front end system 403 can include a serial interface (not shown) that receives commands, and the controller 420 is configured to interpret the commands and output corresponding control signals to the PAs 411a, 411b, LNAs 412a, 412b, band switches 414a, 414b, ASMs 416a, 416b, and/or multiplexer 417, thereby carrying out the commands as instructed by the baseband processor 401 or transceiver 402. As just a couple examples, the controller 420 can output signals for adjusting an enable signal or bias signal of the PAs 411a, 411b and/or LNAs 412a, 412b, and can output signals for actuating the switches 414a, 414b and/or ASMs 416a, 416b.

While FIG. 5 illustrates one embodiment of a front end model 403 that can be used to communicate using FDD, it will be appreciated that other implementations are possible.

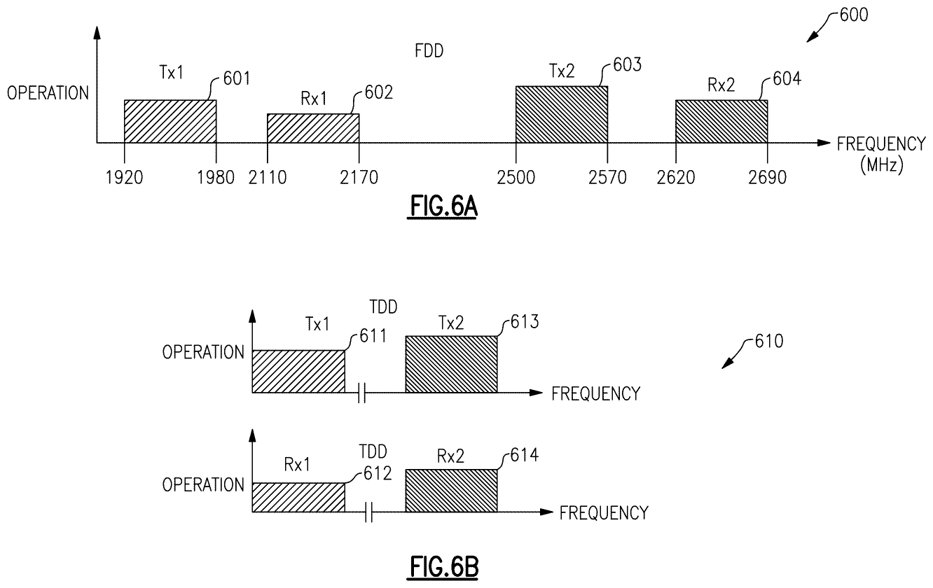

FIG. 6A is a graph illustrating an implementation of FDD communication 600 in the frequency domain in accordance with aspects of this disclosure.

FDD communication 600 is a type of radio frequency communications that uses different frequency ranges for simultaneously transmitting and receiving signals. FDD can provide a number of advantages, such as high data rates and low latency.

FIG. 6A illustrates the operation of UL channels 601, 603 and the operation of DL channels 602, 604 with respect to frequency. For example, the UL channels 601, 603 can correspond to the transmit paths of the first FDD communication path 422 and second FDD communication path 424 of FIG. 5, respectively. The DL channels 602, 604, on the other hand, can correspond to the receive paths of the first FDD communication path 422 and second FDD communication path 424 of the front end system 403 of FIG. 5, respectively. As shown in FIG. 6A, when communicating using FDD, the UL channels 601, 603 may be confined to a first set of respective frequency ranges while the DL channels 602, 604 are confined to a second set of respective frequency ranges. In the specific example shown in FIG. 6A, a first UL channel 601 has signals TX1 that are confined to frequency ranges corresponding to radio frequency band B1 that are transmitted in a frequency range of between approximately 1920 MHz to 1980 MHz, while the second UL channel 603 has signals TX2 that are confined to frequency ranges corresponding to radio frequency band n7 that are transmitted in a frequency range of between approximately 2500 MHz to 2570 MHz.

A first DL channel 602 has signals RX1 that are confined to frequency ranges corresponding to radio frequency band B1 that are received in a frequency range of between approximately 2110 MHz and 2170 MHz, while the second DL channel 604 has signals RX2 that are confined to frequency ranges corresponding to radio frequency band n7 that are received in a frequency range of between approximately 2620 MHz and 2690 MHz.

As shown, in some embodiments, the UL channels 601, 603 and DL channels 602, 604 may be spaced apart by a “Duplex Spacing”, and the allowed frequency passband range of the UL channels is separated from the allowed frequency passband range of the DL channels by a “Duplex Gap” frequency separation. In the illustrated embodiment, the duplex gap between the UL channel 601 and the downlink channel 602 is 30 MHz, and the duplex gap between the UL channel 603 and the downlink channel 604 is 50 MHz.

FIG. 6B is a graph illustrating an implementation of TDD communication 610 in the frequency domain in accordance with aspects of this disclosure.

TDD communication 610 is a type of radio frequency communications where a communication band uses the same frequency channel for transmitting and receiving signals. Because the same frequency is used for transmit and receive, transmitter and receiver cannot operate simultaneously as in FDD communication, and in TDD communications the transmit and receive communication windows are instead separated/switched in time. TDD can provide a number of advantages, such as efficient and flexible use of spectrum between transmit and receive that is adjustable by coordinated time slots, associated variable allocation of throughput between transmit and receive directions, enhanced MIMO benefits as the transmit and receive channels are the same, decreased DC consumption in transmit for a given link budget, etc.

FIG. 6B illustrates the operation of UL channels 611, 613 and the operation of DL channels 612, 614 with respect to frequency at different time periods, since the UL and DL operations are non-concurrent during TDD. As shown in FIG. 6B, during TDD operations UL channel 611 and DL channel 612 may occupy the same respective frequency channel. Additionally, UL channel 613 and DL channel 614 may occupy the same respective frequency channel. Accordingly, instead of being separated by frequency, the UL and DL channels are instead separated in time (not illustrated) to avoid interference between the UL and DL channels.

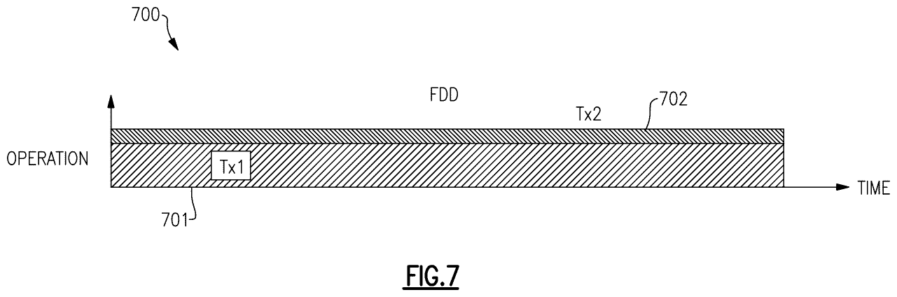

FIG. 7 is a time domain plot 700 illustrating UL channels 701, 702 of two FDD communication paths in accordance with aspects of this disclosure. Because the UL channels 701, 702 are of different FDD bands and therefore have different carrier frequencies, the UL channels 701, 702 can transmit simultaneously and continuously. For example, the first UL channel 701 can correspond to the transmit path of the first FDD communication path 422 of the front end system 403 of FIG. 5, and the second UL channel 702 can correspond to the transmit path of the second FDD communication path 424 of the front end system 403 of FIG. 5.

The simultaneous operation of the UL channels 701, 702 can result in the non-linear mixing of corresponding signals TX1 and TX2 in the RF front end to produce IMD products, which can impact one or more victim RX channels. For example, IMD products resulting from simultaneous FDD operation of the first and second communication paths 422, 424 of the front end system 403 of FIG. 5 can impact one or both of the receive paths of the first and second communication paths 422, 424. It can be difficult to differentiate between the desired receive signal and IMD interference, in some cases causing Rx self-DeSense of more than 20 dB.

Aspects of this disclosure relate to systems and methods which enable IMD to be accurately modelled and subtracted from the RX signal, e.g., such as by subtracting the IMD in the digital baseband by a baseband processor 401.

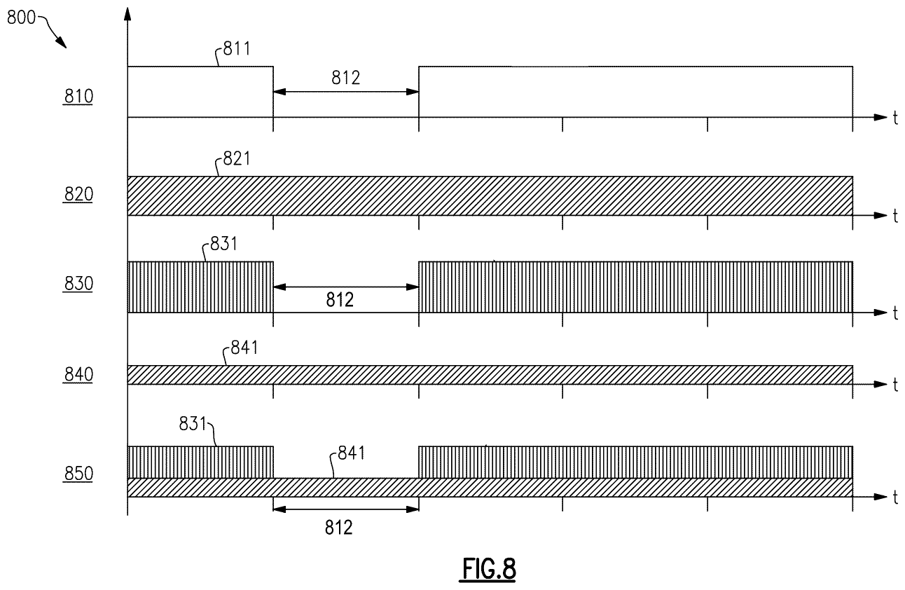

FIG. 8 is a graph 800 illustrating duty cycling of an FDD UL channel in the time domain in accordance with aspects of this disclosure. In some embodiments, the TDD communication 800 may be split into a plurality of frames, each frame having a plurality of slots. In the example shown in FIG. 8, the TDD communication 800 comprises a frame having 5 time slots delineated by the 5 vertical lines extending below each plot on the time axis.

During the frame shown in FIG. 8, a first UL channel and second UL channel respectively transmit a first transmit signal TX1 811 (first plot 810) and a second transmit signal TX2 821 (second plot). The first UL channel and the second UL channel can respectively correspond to the transmit paths of the first and second communication paths 422, 424 of the front end system 403 of FIG. 5, for example.

The first UL channel operates to transmit the TX1 signal 811 for the duration of a first time slot, ceases operation for a second time slot 812, and resumes transmitting TX1 811 for three time slots over the remainder of the illustrated frame, thereby implementing a duty cycle with four ON slots and one OFF slot. On the other hand, the second UL channel 821 operates to continuously transmit TX2 throughout all 5 illustrated time slots.

As discussed, simultaneous transmission of the two FDD UL signals 811, 821 can cause IMD, which is illustrated in FIG. 8 by the IMD signal 831 shown in plot 830. Because the first UL channel is duty cycled, and OFF in the second time slot 812, there is no IMD present during the second time slot 812.

In some embodiments, the duty cycling of the transmit signal TX1 811 is caused by the baseband processor 401. For example, referring to FIGS. 4 and 5, the baseband processor 401 can generate zero value or null value digital signals for the second time slot 812 and provide those digital signals to the transceiver 402. The transceiver 402 can convert the digital signals to a corresponding zero or null value analog radio frequency signal, and output the radio frequency signal to the front end 403. In some embodiments, the mobile device 400 can, instead of or in addition to using the baseband processor 401 and/or transceiver to cause the duty cycling, control the front end system 403 to implement the duty cycling. For example, the baseband processor 401 or transceiver 402 can send commands over a serial interface to the controller 420 of the front end system 403 to cause the power amplifier 411a to output a zero amplitude signal during the time slot 412, such as by disabling the power amplifier 411a or adjusting a bias of the power amplifier 411a.

FIG. 8 also shows a plot 840 of a receive signal RX1 84, e.g., as received by the antenna 404 or as transmitted by a base station, prior to introduction of IMD.

Further, FIG. 8 shows a plot 850 of the receive signal 841 combined with the IMD signal 831. For example, again referring to FIG. 4, the plot 850 may show the DL signal received by first communication path 422 after the IMD has victimized the receive signal.

As shown in the plot 850, because of the duty cycling of transmit signal TX1 811, no IMD signal is produced during the second time slot 812, as TX1 is no longer being transmitted. Then, when transmission of TX1 is resumed after the time slot 812, the IMD signal 831 returns due to the mixing of TX1 and TX2.

Accordingly, as shown in the plot 850, during the first time slot the received signal comprises the combination of the IMD signal 831 and signal 841, during the second time slot 812 the received signal includes only includes the receive signal RX1 841, and for the remainder of the timeframe the received signal 850 comprises the combination of the IMD signal 831 and the receive signal RX1 841.

The duty cycling by the mobile device 400 during one or more time slots allows the mobile device 400 to accurately isolate the IMD signal from the receive signal(s). For example, as shown in FIG. 8, the duty cycling ensures that substantially no IMD is generated during the second time slot 812.

While the example of FIG. 8 shows duty cycling of the TX1 signal 811 (e.g., of the first communication path 422 of the front end system 403 of FIG. 4), it will be appreciated that alternatively the TX2 signal (e.g., of the second communication path 424 of the front end system 403 of FIG. 4) may be subject to a duty cycle to isolate IMD impairment.

The mobile device 400 can process the received signal(s) and/or the known transmit signals TX1, TX2 to isolate the IMD, calculate a transfer function or other representation of the IMD impairment, and process the receive signal to remove the IMD impairment from the victim receive channel. For example, according to certain embodiments, the baseband processor 401 compares digital values corresponding to the received signal 831 during time slot 812 when only the second transmit channel TX2 is transmitting (and there is no IMD) to digital values corresponding to the received signal 831 during one or more of the other time slots when both transmit channels TX1/TX2 are transmitting (and there is IMD) using signal processing techniques to extract a transfer function or other model of the IMD. The baseband processor 401 can also process the known digital transmit values to calculate the IMD. Although not shown in FIG. 8, according to certain embodiments, the baseband processor 401 can then use the calculated IMD transfer function or other model to subtract the IMD from the received signal(s). While in such embodiments the baseband processor 401 performs the subtraction of the IMD digitally (e.g., in a digital signal processor or other microprocessor(s)), in other embodiments, the baseband processor 401 can remove IMD in other ways, such as by adjusting one or more of the transmit signals TX1/TX2 (e.g., using digital predistortion). In some cases, instead of or in addition to subtracting the IMD digitally, the baseband processor 401 can control one or more components of the transceiver 402 (e.g., one or more filters) to remove or reduce the IMD.

In order to provide the uplink UL having a finite duty cycle, a base station scheduler may be managed across all the FDD UL channels operated with a finite duty cycle. The timing of the UL channels is already controlled at the base station and the implementation of timing-advance can be managed in a manner similar to the implementation for the UL of TDD communications. For example, the base station can coordinate with the mobile device to effectuate the duty cycling and the timing thereof.

By enabling a transmission mode where FDD UL can be effectively duty cycled and run in a “TDD-like” operation (e.g., as shown in FIG. 7B), the IMDx can be specifically isolated to enable direct calculation of the transfer function, thereby allowing the IMDx signal impairment to be accurately subtracted by the baseband system 401. This in turn allows for processing gains and significantly enhanced signal-to-noise ratio (SNR) without requiring as much expensive die area and DC voltage consumption required for other known techniques, which eventually reach a dynamic range limit that prevents them from effectively removing the IMDx impairment.

By contrast, aspects of the invention are able to accurately model an IMDx impairment, even for the worst case scenarios, to isolate the desired Rx signal from interference by enabling TDD operation to identify periods of time where IMDx is present and then periods of time where IMDx is absent from the incoming signal.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

1. A mobile device comprising:
an antenna;
a radio frequency front-end module coupled to the antenna, the front-end module including a first radio frequency circuit configured to transmit and receive over a first frequency division duplex communication band, and a second radio frequency circuit configured to transmit and receive over a second frequency division duplex communication band; and
one or more processors configured: to cause the first radio frequency circuit to transmit according to a duty cycle; to analyze a signal received by the first radio frequency circuit during the duty cycling or by the second radio frequency circuit during the duty cycling; and, based on the analysis, to calculate intermodulation distortion between the first radio frequency circuit and the second radio frequency circuit.

2. The mobile device of claim 1 wherein the one or more processors are configured to calculate the intermodulation by determining a transfer function corresponding to the intermodulation distortion.

3. The mobile device of claim 1 wherein the one or more processors are further configured to remove or reduce intermodulation from a received signal based on the calculated intermodulation distortion.

4. The mobile device of claim 1 wherein the one or more processors are configured to analyze the signal received during the duty cycling for at least one period of time when both the first and second radio frequency circuits are transmitting and for at least one period of time when only the second radio frequency circuit is transmitting.

5. The mobile device of claim 1 wherein the first radio frequency circuit and the second radio frequency circuit each include a transmit amplifier, a receive amplifier and a duplexer.

6. The mobile device of claim 1 wherein the front-end module further includes a multiplexer coupled between the first and second radio frequency circuits and the antenna.

7. The mobile device of claim 6 wherein the multiplexer includes a first filter having a pass band that encompasses the first frequency division duplex communication band and a second filter having a pass band that encompasses the second frequency division duplex communication band.

8. The mobile device of claim 1 wherein the first frequency division duplex communication band is a fourth generation (4G) band and the second frequency division duplex communication band is a fifth generation (5G) band.

9. The mobile device of claim 1 wherein the one or more processors reside within a baseband processor of the mobile device.

10. The mobile device of claim 9 further comprising a transceiver coupled between the baseband processor and the front-end module.

11. A radio frequency communication device comprising:
a radio frequency front-end system, the front-end module including a first radio frequency circuit configured to transmit and receive over a first frequency division duplex communication band, and a second radio frequency circuit configured to transmit and receive over a second frequency division duplex communication band; and
one or more processors configured: to cause one of the first radio frequency circuit or the second radio frequency circuit to transmit according to a duty cycle; to analyze a signal received during the duty cycling by the first radio frequency circuit or by the second radio frequency circuit; and, based on the analysis, to calculate intermodulation distortion.

12. The radio frequency communication device of claim 11 wherein the one or more processors are configured to calculate a transfer function corresponding to the intermodulation distortion.

13. The radio frequency communication device of claim 11 wherein the one or more processors are further configured to remove or reduce intermodulation from a received signal based on the calculated intermodulation distortion.

14. The radio frequency communication device of claim 11 wherein the one or more processors are configured to analyze the signal received during the duty cycling for at least one period of time when both the first and second radio frequency circuits are transmitting and for at least another period of time when only one of the first radio frequency circuit and the second radio frequency circuit is transmitting.

15. The radio frequency communication device of claim 11 wherein the one or more processors are configured to cause cessation of the duty cycling and a return to standard frequency division duplex operation after the intermodulation distortion is calculated.

16. The radio frequency communication device of claim 11 wherein the one or more processors are configured to periodically cause the duty cycling.

17. The radio frequency communication device of claim 1 wherein the first frequency division duplex communication band is a fourth generation (4G) band, and the second frequency division duplex communication band is a fifth generation (5G) band.

18. A method of operating a mobile device, the method comprising:
transmitting and receiving over a first frequency division duplex communication band with a first radio frequency circuit of a mobile device;
transmitting and receiving over a second frequency division duplex communication band with a second radio frequency circuit of the mobile device;
causing the first radio frequency circuit to transmit according to a duty cycle;
with one or more processors, analyzing a signal received during the duty cycling by the first radio frequency circuit or by the second radio frequency circuit; and
based on the analysis, calculating, with the one or more processors, intermodulation distortion between the first radio frequency circuit and the second radio frequency ciruit.

19. The method of claim 18 further comprising, with the one or more processors, calculating a transfer function corresponding to the intermodulation distortion.

20. The method of claim 18 further comprising, with the one or more processors, removing or reducing intermodulation from a received signal based on the calculated intermodulation distortion.
